(19) United States
(12) Patent Application Publication
(10) Pub. No.: US 2013/0297521 A1
(43) Pub. Date: Nov. 7, 2013

(54) METHODS AND APPARATUS FOR DONATING ONE OR MORE ITEMS

(71) Applicants: David Campbell, Allston, MA (US); Michael Stone, Allston, MA (US)

(72) Inventors: David Campbell, Allston, MA (US); Michael Stone, Allston, MA (US)

(21) Appl. No.: 13/740,518

(22) Filed: Jan. 14, 2013

Related U.S. Application Data
(60) Provisional application No. 61/642,700, filed on May 4, 2012.

(51) Int. Cl. G06Q 10/06

(52) U.S. Cl. CPC G06Q 10/06
USPC 705/329

(57) ABSTRACT

According to some aspects, a computer-implemented method for donating one or more items to at least one recipient selected from a plurality of potential recipients is provided. The method comprises using at least one processor to perform presenting the donor with a plurality of items that a selected recipient desires to receive as a donation, receiving first input indicating the donor's selection of at least one item from the plurality of items, and interacting with the donor to allow the donor to donate at least a portion of the at least one selected item to the selected recipient.

### CROSS-REFERENCE TO RELATED APPLICATIONS

The present application claims the benefit under 35 U.S.C. §119(e) of U.S. Provisional Application Ser. No. 61/642,700, filed on May 4, 2012, titled “Methods and Apparatus for Donating One or More Items,” which is hereby incorporated by reference in its entirety.

### BACKGROUND

People are charitable. Monetary donations are given to different types of recipients including individuals, groups of individuals, charities, non-profit organizations, and various other charitable entities. People and/or organizations decide how much and where to donate their money for numerous reasons. For example, a person may donate money to one or more recipients doing work related to a cause that the person cares about and to which he or she wishes to contribute, or organizations may donate to other organizations or individuals related to matters or issues of their concern.

However, a person/organization that wishes to donate money to a particular cause may be faced with the problem of deciding how to choose where he or she should donate that money and/or how much money should be contributed (e.g., how much money provides some desired level of good to the recipient). Indeed, there may be many individuals, non-profit organizations, and other entities that do work related to causes that the person cares about and that are in need of donations, but the individual or organization may be unsure of how to identify them or understand what amount is appropriate or desired.

Conventional techniques for helping people identify where to donate money include providing an interface that enables people to search for individuals, groups, charities, and other organizations to which they may wish to donate money. For example, a donor could access a website that provides a listing of charities and search the listing based on factors important to the donor (e.g., charity type, reputation of organization, geographic location, etc.) in order to identify where to donate money.

### SUMMARY

In some embodiments, techniques for donating one or more items to a recipient non-profit organization are disclosed. The techniques comprise identifying the recipient non-profit organization from a plurality of non-profit organizations, selecting one or more items indicated by the recipient non-profit organization as items that the recipient non-profit organization desires to receive, and donating the one or more selected items to the recipient non-profit organization, wherein the donating comprises purchasing the one or more selected items on behalf of the recipient. Identifying the recipient non-profit organization comprises identifying a category of non-profit organizations and selecting the recipient non-profit organization from a set of non-profit organizations associated with the identified category. Such techniques may be embodied as a computer-implemented method. Further, such techniques may be embodied, as a system comprising at least one processor configured to execute the computer-implemented method, and as at least one non-transitory computer-readable storage medium storing processor-executable instructions, that when executed by at least one processor, cause the at least one processor to execute the computer-implemented method.

Some embodiments include a computer system configured to assist in donating one or more items to at least one recipient selected from a plurality of potential recipients. The computer system comprises at least one computer readable medium for storing information regarding the plurality of potential recipients and, for each of the plurality of potential recipients, storing information regarding a plurality of items the respective potential recipient would like to receive as a donation, and at least one processor capable of receiving information stored on the at least one computer readable medium, the at least one processor configured to perform presenting the donor with a plurality of items that a selected recipient desires to receive as a donation, receiving first input indicating the donor's selection of at least one item from the plurality of items, and interacting with the donor to allow the donor to donate at least a portion of the at least one selected item to the selected recipient.

Some embodiments include a computer-implemented method for donating one or more items to at least one recipient selected from a plurality of potential recipients, the method comprising using at least one processor to perform presenting the donor with a plurality of items that a selected recipient desires to receive as a donation, receiving first input indicating the donor's selection of at least one item from the plurality of items, and interacting with the donor to allow the donor to donate at least a portion of the at least one selected item to the selected recipient.

Some embodiments include at least one computer-readable medium encoded with instructions that, when executed on at least one computer, perform a method of donating one or more items to at least one recipient selected from a plurality of potential recipients, the method comprising presenting the donor with a plurality of items that a selected recipient desires to receive as a donation, receiving first input indicating the donor's selection of at least one item from the plurality of items, and interacting with the donor to allow the donor to donate at least a portion of the at least one selected item to the selected recipient.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an exemplary computing environment for enabling the donation of one or more items to one or more recipients, in accordance with some embodiments of the present invention.

FIG. 2 shows a flowchart of a method for donating one or more items to at least one recipient, in accordance with some embodiments of the present invention.

FIG. 3 shows a flowchart of a method for creating a wishlist of items associated with a recipient, in accordance with some embodiments of the present invention.

FIG. 4 illustrates an example of how multiple recipients may be categorized, in accordance with some embodiments of the present invention.

FIG. 5 is a block diagram generally illustrating an example of a computer system that may be used in implementing aspects of the present invention.

### DETAILED DESCRIPTION

Conventional systems that allow donors to donate money to a recipient (e.g., individual, groups of individuals, charitable organization or service) are generally limited to facilitating monetary donations. However, there may be substantial drawbacks associated with monetary donations. First, donors may feel unsatisfied with monetary donations at least in part because they likely will never learn how that money materializes into actual good for the recipient. In addition, there may be a sense that only some fraction of money being donated actually goes toward purchasing some good or providing some service to the recipient, and the remainder goes to overhead, bureaucracy, and/or into the organization. Finally, it may be difficult to identify an appropriate amount to donate because of the difficulty in understanding how the money translates into an actual good or act of donation.

The inventors have recognized and appreciated that, in addition to or instead of donating money, donors may wish to donate one or more items to one or more recipients. For instance, a donor may wish to donate items such as sporting equipment, medical supplies, office supplies, school supplies, goods used by a shelter, and/or any of other numerous types of items that support a charitable entity and/or its recipients. In contrast to donating money, donating one or more items to a recipient provides a donor with knowledge about how the donor's generosity is used to benefit the recipient. In turn, a recipient of a donated item or items may quickly put the donated item(s) to use.

In many instances, donating one or more items eliminates the need to have personnel operating on behalf of the recipient handle the money and/or convert the funds into the intended good(s). As such, more of the value of the charitable act is realized because this overhead may no longer be part of the donation process. A donor's generosity may be more fully realized without loss in overhead, conversion, bureaucracy, and/or other inefficiencies that recipient organizations may be vulnerable to.

The inventors have also recognized and appreciated that donors who wish to donate one or more items to recipients may not know how to identify a recipient to which they wish to donate the item(s). Moreover, even if a donor were to identify such a recipient, the donor may not know what items may be desired by the recipient and/or how to donate these item(s) to the recipient. The inventors have further recognized and appreciated that the above-mentioned conventional techniques for helping donors identify where and how to donate money do not help donors identify where and how to donate items, and which items are desired by selected charitable entities.

Accordingly, in some embodiments, techniques are provided for enabling donors to donate one or more items to one or more recipients. In some embodiments, a system may be configured to enable a donor to select a recipient to which the donor may donate one or more items. The system may be configured to present the donor with a list of items associated with the selected recipient, the list of items containing information about items that the selected recipient may desire and/or need. Accordingly, such a “wishlist” (also referred to as a “needs list”) for each charitable entity may be provided. In turn, the donor may use the system to select one or more items identified in the wishlist that the donor would like to donate to the selected recipient. After receiving a selection of one or more items from the donor, the system may enable the donor to purchase the selected item(s) so that these item(s) may be provided to the selected recipient.

For example, in some embodiments, a donor may use a website to select a recipient to which the donor wishes to donate one or more items. The website may provide the donor with information about various recipients and organize recipients into categories to help the donor select a recipient. The website may be any suitable website and may be operated by or on behalf of any suitable entity (e.g., a business, a non-profit, one or more individual etc.). After a donor selects a recipient, the website may present the donor with a wishlist identifying items the selected recipient desires to receive or has indicated that the recipient can make use of. The donor may select one or more of the items identified in the wishlist to donate to the recipient and be directed to a transactional website where he or she may purchase the selected item(s) so that they may be provided to the recipient. The one or more donated items may then be directly shipped to the recipient.

In some embodiments, software developed to facilitate presenting items for donation, selecting items for donation and/or facilitating a transaction to donate one or more items electronically, may be implemented on the website belonging to a recipient (e.g., a non-profit organization). As such, a donor may use a website operated by or on behalf of recipient that allows the donor to donate one or more items to the recipient through the website. For example, a non-profit organization's (or any other suitable recipient's) website may allow donors who visit the website to view a wishlist identifying items that the non-profit organization desire to receive or has indicated that it can make use of. The donor may use the non-profit's website to select on or more of the items identified in the non-profits wishlist to donate to the non-profit and, subsequently, be directed to a transactional website where he or she may purchase the selected item(s) so that they may be provided to the recipient.

The transactional website may be part of the website the donor used to select the item(s) the donor may purchase or may be a separate website, such as a website of an online store and/or other third party website. Though, it should be recognized that aspects of the present invention are not limited to using one or more web sites to donate items to recipients as any other suitable computer-implemented interface may be used to enable donors to donate items to recipients.

A donor may donate an item by selecting the item and being charged for its purchase. However, in some embodiments, a donor may donate a portion of an item by selecting the item and being charged for a portion of the cost of its purchase. As such multiple donors may each contribute partially to a high-cost item, thereby increasing the likelihood that a relatively large-ticket item will be donated even when the cost may exceed the capabilities of a single donor. Recipients may also be more likely to request more expensive items that are needed when recipients understand that such items may be purchased collectively by multiple donors.

In some embodiments, a system for enabling donors to donate items to recipients may also be configured to enable recipients to create wishlists of items. A recipient may use the system to create and/or edit a wishlist identifying one or more items that the charitable entity desires to receive to benefit one or more recipients. A created wishlist may be presented to one or more donors such that the donors may select one or more items identified in the wishlist to donate to the recipient associated with the wishlist.

Multiple donors may each donate one or more items to a recipient. In some embodiments, a system for enabling donors to donate items to recipients may collect information about the donors and provide at least a portion of the collected information to the recipients. A recipient may use the collected information in any suitable way and, for example, may use the collected information to thank the donors for their donations.

A donor may be any suitable entity or collection of entities seeking to make one or more donations. For example, the donor may be a human, a collection of humans, a commercial or non-commercial organization, a collection of commercial or non-commercial organizations, or any other suitable entity.

A donor may donate any of numerous types of items. The donor may donate any item that may be used by the recipient of the item. The donor may donate any item that may be purchased electronically (e.g., purchased over the Internet using an online store) or otherwise purchased by providing an indication that the donor would like to donate a given item(s). As described below, in some embodiments, donating an item may comprise donating one or more goods. In some embodiments, donating an item may comprise donating one or more services.

A good may be anything, other than money, that is movable, and includes, but is not limited to, various types of merchandise. Examples of goods include, but are not limited to, print and electronic media (e.g., books, CDs, DVDs, etc.), electronics (e.g., televisions, video cameras, photo cameras, cell phones, etc.), appliances, computers (e.g., desktops, laptops, personal digital assistants, tablet computers, etc.), kitchen supplies, furniture, bedding supplies, dining supplies, garden and landscaping supplies, tools, building materials, arts and crafts supplies, pet supplies, food, health and personal care products, beauty products, toys, games, baby supplies, clothing, shoes, bags, luggage, jewelry, decorations, sporting equipment, outdoors equipment, school supplies, office supplies, medical supplies, lamps and light fixtures, transportation goods (e.g., bicycles, cars, motorbikes, etc.), and any of other numerous goods.

A further example of donating an item includes donating a service, such as a service to be performed for a recipient (e.g., a grocery delivery service for an elderly recipient, or donating an information technology (IT) service to assist in building, maintaining and/or fixing a non-profit organization's network infrastructure). A donor may donate a service to a recipient by purchasing the service to be provided to the recipient. The service may be any of numerous types of services and, for example, may be a service provided by entities including, but not limited to, a general contractor, an electrician, a plumber, a doctor, an entertainer, an attorney, an accountant, a financial planner, a real estate professional, and a computer specialist. As an example, donating a service may comprise donating money toward paying for a staff position needed by the recipient to carry out its charitable actions more effectively. Though, it should be recognized that donors are not limited to donating items and may donate anything else such as money to recipients or may donate their own time to recipients by volunteering.

It should be appreciated that donating an item to a recipient is different from giving one or more gifts to one or more people. For example, buying an item for one or more people via a wedding registry, a baby registry, etc., does not constitute donating, but rather constitutes providing a gift. As another example, purchasing items online as gifts to one or more people on special occasions (e.g., birthdays, holidays, etc.) does not constitute donating item(s). Donating an item may comprise donating the item to a recipient in need of the item that is not related to the donor and/or donating to a recipient that the donor does not know personally. Donations are frequently made from a donor to an organization, and often (but not always) to an organization to which the donor is not employed.

A recipient of a donation may be any suitable entity or collection of entities capable of receiving one or more donations. For example, a recipient may be a human, a collection of humans, a commercial or non-commercial organization, a collection of commercial or non-commercial organizations, or any other suitable entity. In some embodiments, a recipient may be a not-for-profit (i.e., non-profit) organization. The recipient may be any suitable type of non-profit organization and, for example, may be any non-profit organization recognized as such under Section 501(c) of the United States Internal Revenue Code (26 U.S.C. §501(c)).

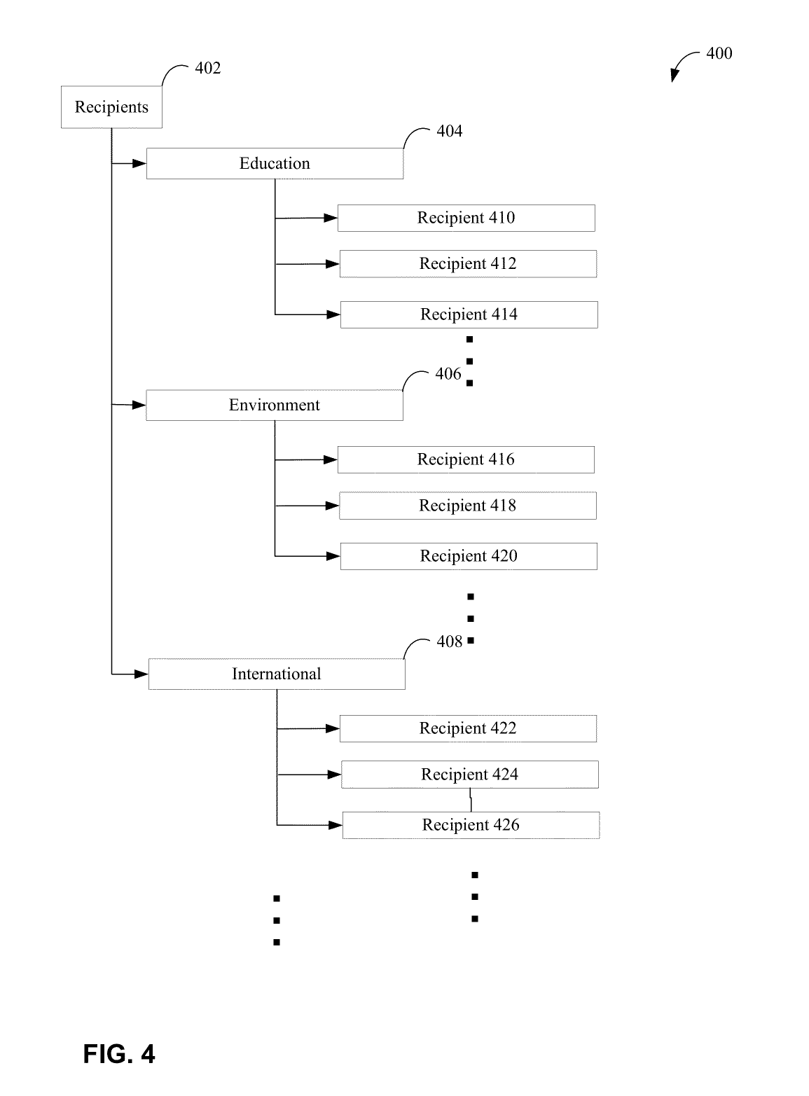

In some embodiments, a system enabling donors to donate items to recipients may organize recipients so as to help the donor identify one or more recipients to which the donor may donate one or more items. Recipients may be organized in any suitable way and, for example, may be organized hierarchically, topically, and/or categorically. For instance, recipients may be organized into categories that donors may use to identify a recipient to which to donate one or more items. The system may also provide a search feature or search functionality that allows potential donors to search for a desired recipient, for example, by performing a keyword search. Organization of recipients is discussed in greater detail below with reference to FIG. 4.

Aspects of the techniques described herein facilitate the deployment of an electronic donation (e-donation) system that provides access to numerous potential recipients, indication of items those recipients need, and mechanisms to donate those items electronically from anywhere a suitably networked computer is available, making a reality what would not be possible without the functionality provided by computer and network systems, electronic processing capabilities and/or electronic interfaces (e.g., websites and web presentations).

Following below are more detailed descriptions of various concepts related to, and embodiments of, methods and apparatus according to the present invention. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

Some benefits derived from the inventor's insights may only be realized by virtue of implementing item donation on one or more computers, as such donation mechanisms, even if in theory possible, would not be practicable or even useable unless performed by one or more computers and/or via one or more networks. Furthermore, some advantages derived from the inventor's innovation result from donors being able to electronically access wish lists or needs lists over a network (e.g., via web access over the Internet), so that donation resources are generally available to anyone anywhere. Such advantages are generally not capable of being exploited using manual approaches. Computer implementation, presentation and/or access are integral aspects of some embodiments.

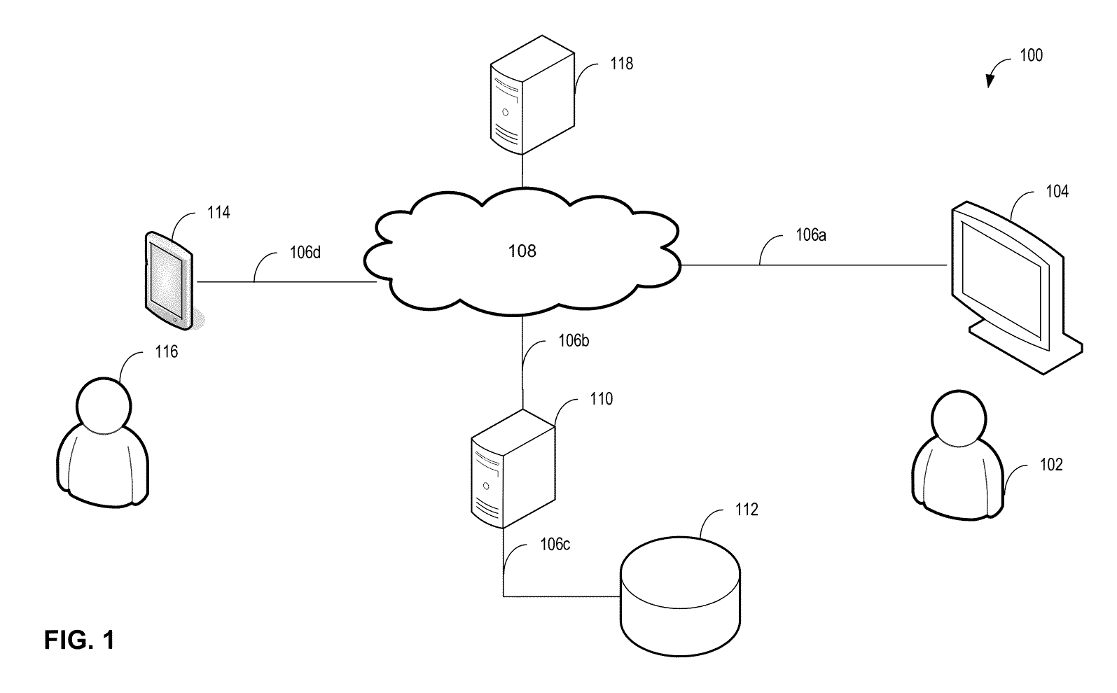

FIG. 1 shows an illustrative computing environment 100 on which various aspects of donating one or more items to one or more recipients may be implemented. Computing environment 100 allows recipient 102 to create one or more wishlists identifying items that recipient 102 desires. To this end, computing environment 100 includes computing device 104 that allows recipient 102 to input information indicative of one or more items that recipient 102 desires. Computing device 104 also may allow recipient 102 to input information about itself so that this information may be provided to donors who may be considering whether to donate one or more items to recipient 102. Computing device 104 may be any suitable computing device as this is not a limitation of aspects of the present invention.

Computing device 104 may be configured to provide any information input by recipient 102 to server 110, which may use this information to create at least one wishlist associated with recipient 102. The created wishlist may identify one or more items indicated by recipient 102 as being items that recipient 102 desires. Additionally, the created wishlist may include information associated with the identified items. Information associated with an identified item may be information including, but not limited to, a price of the item, a quantity of the item desired by recipient 102, a textual and/or visual description of the item, one or more reviews of the item, description of one or more characteristics of the item, and a description of why recipient 102 desires the item.

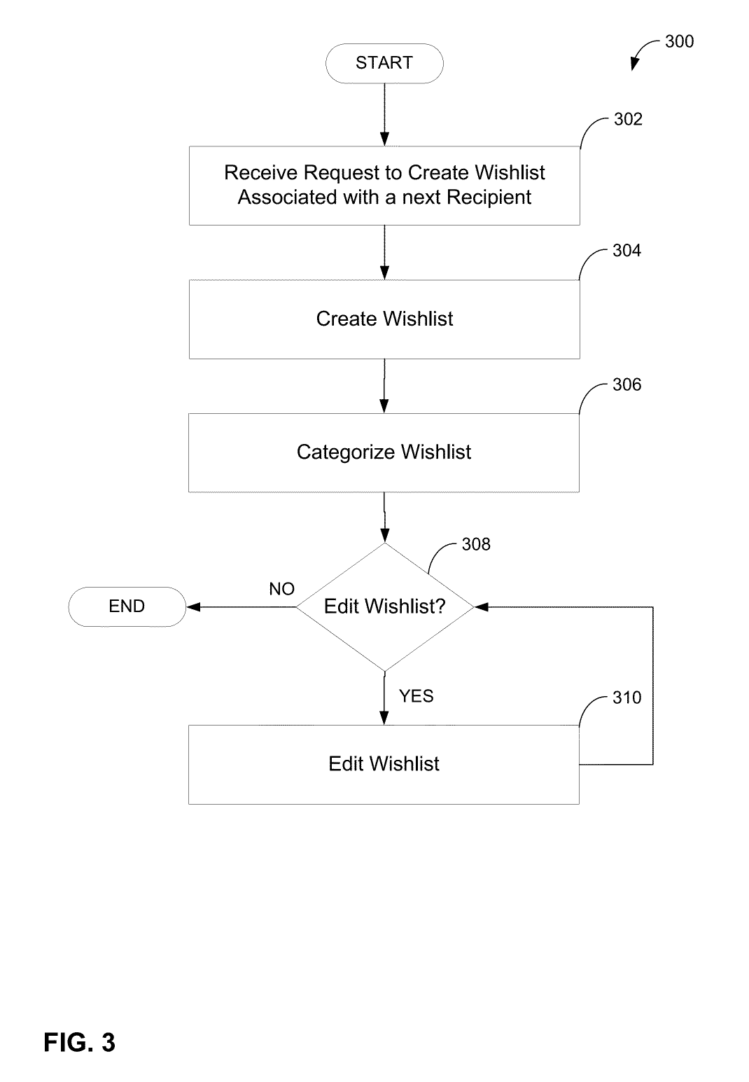

Additionally, the created wishlist may contain information about recipient 102. Information about recipient 102 may include any suitable information including, but not limited to, a name identifying the recipient (e.g., name of a non-profit organization, name of an individual, etc.), description of the recipient's mission and/or goal (e.g., goal of a non-profit organization, goal of an individual, etc.), contact information associated with the recipient (e.g., one or more mailing addresses, one or more e-mail addresses, one or more telephone numbers, one or more websites, etc.), a value indicative of the total number of items that the recipient desires, a value indicative of the total number of items that the recipient has received, and/or any other suitable information. Techniques for creating and/or editing a wishlist associated with a recipient are described in greater detail below with reference to FIG. 3.

Server 110 may receive information provided by recipient 102 in any suitable way. For example, server 110 may be communicatively coupled to computing device 104 and may receive information provided by recipient 102 by communicating with computing device 104. In the illustrated embodiment, server 110 and computing device 104 are communicatively coupled via communication links 106a and 106 b and network 108. Network 108 may be any suitable type of network such as a local area network, a wide area network, the Internet, an intranet, or any other suitable network. Though, it should be recognized that server 110 may be communicatively coupled to computing device 104 in any suitable way, using any suitable types of connections (e.g., wired, wireless, etc.), as the invention is not limited in this respect. Computing device 104 and server 110 may communicate through any suitable networking protocol (e.g., TCP/IP) because the manner in which information is transferred between server 110 and computing device 104 is not a limitation of aspects of the present invention.

Server 110 may store any information related to one or more recipients (e.g., recipient 102) in data store 112, which is communicatively coupled to server 110 via communication link 106c. For example, server 110 may store information about the recipient(s) in data store 112. As another example, server 110 may store information associated with one or more items that the recipient(s) may desire in data store 112. The information stored in data store 112 may be stored in any suitable way and in any suitable format as aspects of the present invention are not limited in this respect.

Additionally, data store 112 may store any suitable information about one or more donors. For example, data store 112 may store information about a donor, the donor's contact information, information indicating which recipient or recipients the donor donated one or more items to, information indicating what items the donor donated to which recipient, etc. Data store 112 may be implemented in any suitable way, may be part of the server 110 or separate from it, and may be connected to the server in any suitable way, as the aspects of the present invention are not limited in this respect.

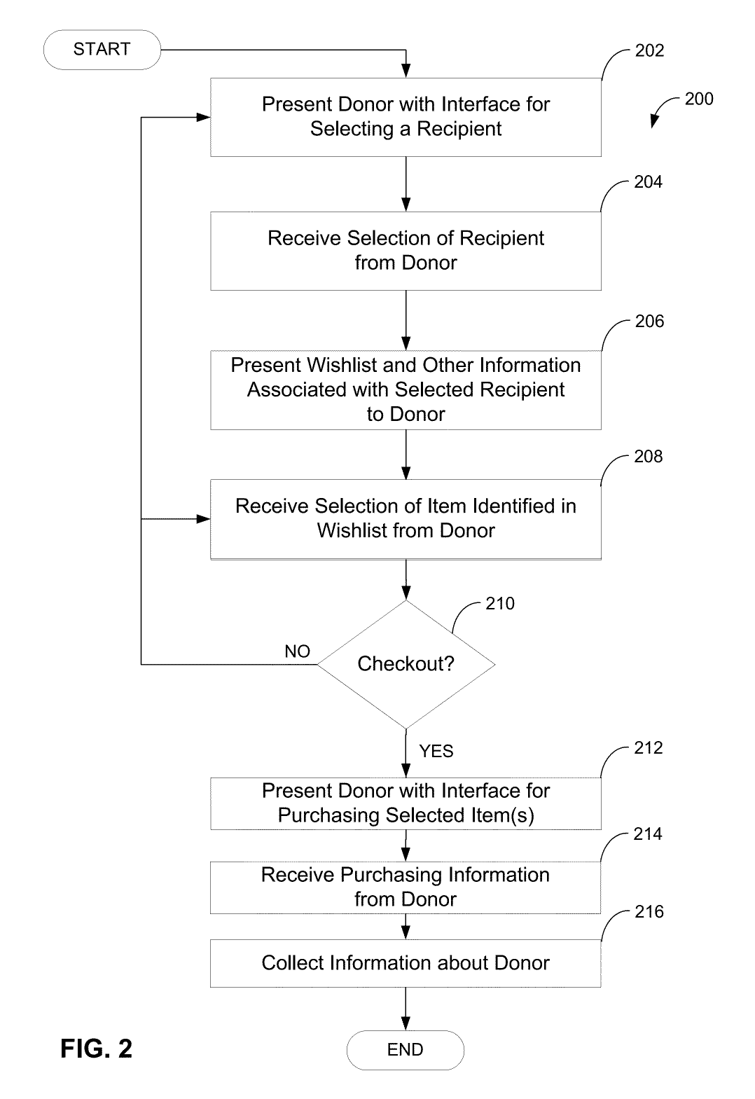

Computing environment 100 enables one or more donors to donate one or more items to one or more recipients. To this end, donor 116 may use computing device 114 to connect to server 110, and server 110 may present donor 116 with an interface that enables donor 116 to identify one or more recipients to which donor 116 may donate one or more items. Donor 116 may further operate computing device 114 to select one or more recipients to which donor 116 may donate one or more items. Upon receiving such a selection, server 110 may present donor 116, for each selected recipient, with information about the recipient and a wishlist identifying items that the recipient desires. Donor 116 may further operate computing device 114 to select one or more items identified in the wishlist to donate to the selected recipient(s). Server 110 may perform further acts to enable donor 116 to purchase the selected items such that the selected items may be provided to the intended recipient(s). As such, server 110 allows donor 116 to donate one or more items identified in the wishlist associated with the recipient. Techniques for donating one or more items to a recipient are described in greater detail below with respect to FIG. 2.

In the illustrated embodiment, computing device 114 is connected via communication link 106d to network 108 and may communicate through network 108 with server 110. Computing device 114 and server 110 may communicate through any suitable networking protocol (e.g., TCP/IP) because the manner in which information is transferred between server 110 and computing device 114 is not a limitation of aspects of the present invention.

Server 110 may be operated by any or on behalf of any suitable entity for the purpose of enabling donors to donate items to recipients. For example, server 110 may be operated by a commercial or a non-commercial organization (or on behalf of a commercial or a non-commercial organization) to enable donors to donate items to recipients and/or to enable recipients to specify one or more items that they need and/or desire. As another example, server 110 may be operated by a commercial organization, such as an online store, that sells (directly or as a third party) items that recipients may desire to receive from donors and/or items that donors may seek to donate to recipients.

Components of computing environment 100 may perform any of numerous functions related to allowing a donor to donate one or more items to one or more recipients. These functions include, but are not limited to, presenting the donor with information enabling the donor to select one or more recipients, presenting the donor with information to select one or more items to donate to the selected recipient(s), and to purchase the selected item(s) such that the item(s) may be provided to the recipient(s). In some embodiments, all these functions may be performed by server 110. Additionally or alternatively, one or more of these functions may be performed by another component of computing environment 100.

In the illustrated embodiment of FIG. 1, for instance, online store server 118 may perform functions enabling donor 116 to purchase one or more selected items so that these items may be provided to the intended recipient(s). In some embodiments, including the embodiment illustrated in FIG. 1, items identified in a wishlist associated with a recipient may be items that may be purchased at an online store. Accordingly, after server 110 receives a selection of one or more items that donor 116 wishes to donate to one or more recipients, server 110 may provide online store server 118 with any suitable information online store server 118 needs to enable donor 116 to purchase the selected item(s). Online store server 118 may interact with donor 116 to complete any transactions associated with the donation. In some instances, online store server 118 and server 110 may be operated by the same entity, while, in other instances, online store server 118 and server 110 may be operated by different entities.

It should be appreciated that computing environment 100 is merely illustrative and that there are many possible variations of computing environment 100. For example, a single recipient (recipient 102) and a single donor (donor 116) are shown in the illustrated embodiment for simplicity of illustration. However, it should be recognized that computing environment 100 may be used by any suitable number of donors to donate items to any suitable number of recipients, and that computing environment 100 may be used by any suitable number of recipients to provide information for the creation of wishlists identifying items that the recipients desire.

Computing environment 100 may be used to implement any suitable technique or techniques for enabling donors to donate one or more items to recipients. One such technique is illustrated in FIG. 2, which is a flowchart of illustrative process 200 for donating one or more items to one or more recipients. It should be appreciated that acts of process 200 may be performed by one or more components of computing environment 100 including, but not limited to, server 110 and online store server 118.

Process 200 begins in act 202, where a donor is presented with an interface for selecting a recipient. The interface may be any suitable type of interface and may include a graphical user interface. For example, the interface may be an Internet-based interface configured to provide the donor with information by using one or more webpages. Such an interface may be further configured to receive any of numerous types of input from the donor including, but not limited to, input provided by the donor using a keyboard, a mouse, a microphone, a stylus, or in any other suitable way as the invention is not limited in this respect.

The interface may be configured to present to the donor any suitable information that the donor may use to select one or more recipients to which to donate one or more items. For example, the interface may be configured to present a list of one or more recipients to the donor. For any recipient in the list of recipients, the interface may be further configured to present information about the recipient to the donor. Information about a recipient may include any of the types of information previously mentioned including, but not limited to, a name identifying the recipient, a description of the recipient's mission and/or goal, contact information associated with the recipient, a value indicative of the total number of items that the recipient desires, and a value indicative of the total number of items that the recipient has received. Information about the recipient may be presented in any suitable format, as the present invention is not limited in this respect.

As a specific example, when a recipient is a non-profit organization, the interface may be configured to present, to one or more donors, various information about the non-profit organization. For example, the interface may be configured to present the non-profit organization's name, a description of its mission or missions, its contact information, etc.

The list of recipients may be organized and/or presented in any suitable way. The list of recipients may be organized hierarchically, topically, and/or categorically. For example, the list of recipients may be organized as shown in FIG. 4. In FIG. 4, list of recipients 402 comprising a list of non-profit organizations is organized using multiple categories. In particular, recipients 410, 412, and 414 are assigned to the education category 404. Recipients 416, 418, and 420 are assigned to the environment category 406. And, recipients 422, 424, and 426 are assigned to the international category 408. Though, it should be recognized that the hierarchical organization 400, shown in FIG. 4, is merely illustrative and recipients (either nonprofit organizations and/or any other type of recipients) may be organized in any other suitable way. The available recipient may also be searchable, so that a donor can search for one or more desired recipients based on recipient name, entity or recipient type, geographic location, or any other search criteria.

Accordingly, a list of recipients may be presented to a donor in accordance with the way in which the list of recipients may be organized. For example, when the list of recipients is organized using one or more categories, the donor may be presented with a list of categories and, in response to a selection of a category by the donor, may be configured to present the donor with one or more recipients assigned to the category selected by the donor. As a specific example, the donor may be presented with a webpage containing a list of categories, each category being associated with an area of activity for one or more non-profits. The donor may select a category (e.g., education, environment, homelessness, international development, etc.) and, in response to the selection, the donor may be presented with a list of one or more non-profits associated with the selected category.

Next, process 200 proceeds to act 204, where a selection of at least one recipient may be received from the donor. The selection may be received in any suitable way and, for example, may be received as a result of a donor providing input to the interface. As a specific example, the donor may select a recipient on a webpage showing one or more recipients (e.g., by clicking on a link or information associated with the recipient or in any other suitable way).

Next, process 200 proceeds to act 206, where a wishlist associated with the recipient selected by the donor may be presented to the donor. The wishlist associated with the selected recipient may be any suitable wishlist and may identify one or more items that the selected recipient desires and/or needs. Accordingly, presenting a wishlist to the donor may comprise providing information about one or more items identified in the wishlist to the donor. Information about an item may be any of the previously-mentioned types of information including, but not limited to, a price of the item, a quantity of the item desired by the recipient, a textual and/or a visual description of the item, one or more review of the item, description of one or more characteristics of the item, and a description of why the recipient desires the item (such a description may help the donor pick the item or items to donate to the recipient). For example, if a wishlist associated with the non-profit organization were to identify that a particular tool (or any other suitable item) were desired by the non-profit organization, presenting information about the tool to the donor may comprise providing the donor with the price of the tool, a picture of the tool, and a reason for why the non-profit organization desires to receive the tool.

Next, process 200 proceeds to act 208, where a selection of at least one item, identified in the wishlist presented to the donor, may be received from the donor. The selection may be received by any component of a system configured to execute act 208 of process 200. The selection may be received in any suitable way and, for example, may be received as a result of a donor providing input to the interface. As a specific example, the donor may select one or more items on a webpage (e.g., by clicking on a link or information associated with the item(s) or in any other suitable way). For each selected item, the donor may specify a quantity of each item that the donor wishes to donate to the recipient. As previously mentioned, in some embodiments, a donor may wish to donate a portion of an item to the recipient (e.g., the donor may wish to pay for a portion of the cost of the item). To this end, the donor may specify an amount that the donor may wish to donate toward the cost of the item.

Information identifying the items selected by the donor may be stored. This information may be stored in any suitable way, for any suitable period time, and for any suitable purpose. For example, the information identifying the selected items may be stored so that it may be subsequently accessed to allow the donor to review the selections, edit the selections (e.g., remove an item previously selected, change the quantity of a selected item that the donor wishes to donate, etc.), and/or purchase the one or more selected items. Information identifying the selected items may be stored using any suitable techniques and, for example, may be stored using “a shopping cart” as known in the art.

Next, process 200 proceeds to decision block 210, where a determination is made as to whether the donor wishes to purchase the one or more selected items or continue browsing for one or more other items to donate. This determination may be made in any suitable way and, for example, may be made based at least in part on input from the donor. For example, the donor may provide input indicating that the donor wishes to purchase the selected items or the donor may provide input indicating that the donor wishes to continue browsing for one or more other items to donate.

If it is determined in decision block 210, that the donor wishes to continue browsing for one or more other items, process 200 loops back, via the “NO” branch, either to act 202 and acts 202-208 and decision block 210 are repeated or to act 208 and acts 208 and decision block 210 are repeated. On the other hand, if it is determined in decision block 212 that the donor wishes to purchase the one or more items already selected by the donor, process 200 proceeds, via the “YES” branch, to acts 212, 214, and 216.

In act 212, the donor may be presented with a purchasing interface configured to enable the donor to purchase the selected item(s) and, in act 214, information needed to complete the purchase of at least one of the selected items may be received from the donor. The received information may include payment information (e.g., one or more credit card numbers, one or more debit card numbers, one or more bank account numbers, one or more online payment system numbers, a mailing address or an e-mail address for where to send a bill, etc.). As another example, the received information may include information about how to ship the selected items to the recipient (e.g., what shipping service to use, how quickly to deliver the selected items, whether to giftwrap the selected items, etc.). Though, it should be recognized that these are only examples and that any other suitable information may be received from the donor using a purchasing interface.

Next, process 200 proceeds to act 216, where information about a donor may be collected. Information about a donor may be any of the types of information previously described including, but not limited to, the donor's contact information, demographic information associated with the donor, information indicating which recipient or recipients the donor donated one or more items to, and information indicating what items the donor donated to which recipient.

The information collected during act 216 may be used for any of numerous purposes. For example, the information about a donor may be provided to a recipient of an item donated to the recipient by the donor. As such, recipients of donated items may obtain information about donors of the donated items and may use it for any suitable purpose such as to thank the donors for their donations. As another example, information about the donor may be stored so that it may be accessed at a later time. A donor may wish to donate an item or items at a first time and another item or items at a second later time. Storing information collected about the donor at the first time may be used when the donor is in the process of donating an item or items at the second time. For example, using such information may expedite the donation process by eliminating the need for a donor to re-enter information required to make a donation. Though, it should be recognized that the collected information may be used for any other suitable purpose. After act 216, process 200 completes.

In some embodiments, acts 212-216 may be performed by the same entity that may perform acts 202-208. For example, acts 212-216 may be performed by one or more computing devices operated by an entity that is operating a website that allows donors to donate one or more items to one or more recipients. However, in other embodiments, acts 212-216 may be performed at least in part by one or more computing devices operated by an entity different from the entity operating a computing device or devices that perform acts 202-208. For example, acts 212-216 may be performed by one or more computing devices operated by an entity operating an online store selling at least one of the items selected by a donor.

It should be recognized that process 200 is illustrative and that many variations of process 200 are possible. For example, although in the illustrated embodiment, the donor may purchase one or more selected items in acts 212-214, in other embodiments, the selected items may be saved and the donor may purchase the selected items at a later time. As another example, although the illustrated embodiment was described only with respect to a single donor, the process is not limited in this way. In particular, process 200 may be adapted to enable any suitable number of donors to donate one or more items to any suitable number of recipients. In addition, not all of the acts described above need to be performed and the acts may be performed in a different order than described in process 200.

As previously mentioned, computing environment 100 may be used to implement techniques enabling recipients to identify items that the recipients may desire to be donated to them. One such technique is illustrated in FIG. 3, which is a flowchart of illustrative process 300 for creating a wishlist of items associated with a recipient. It should be appreciated, that acts of process 300 may be performed by one or more components of computing environment 100 including, but not limited to, server 110 and computing device 104.

Process 300 begins in act 302, where a request may be received to create a wishlist associated with a recipient. The request may be received from the recipient or from any other entity acting on behalf of the recipient. The request may be in any suitable format, as the format of the request is not a limitation of aspects of the present invention.

The request to create a wishlist may comprise any suitable information. For example, the request may comprise information about the recipient including, but not limited to any of the previously described information about the recipient (e.g., name, address, etc.). The request may further comprise organization information if the recipient is a commercial or non-commercial organization. As a specific example, if the recipient is a nonprofit organization, the request may comprise information that may be used to verify whether the recipient is a non-profit organization. Such information may include identification information that may be used to confirm whether the non-profit organization is a non-profit organization in accordance with the provisions of 26 U.S.C. §501(c).

In some embodiments, the organization may be required to be a non-profit organization to participate in the donation system. To this end, the non-profit status of each organization may be verified. The verification may occur before the creation of any wishlist by or on behalf of the organization or after such a wishlist is created. The verification may be performed automatically or at least in part with manual intervention, as the aspects are not limited by when or how the verification of an organization's status is performed.

In some instances, the request may comprise information identifying one or more items that the recipient desires to receive. However, in other instances, the request may not identify any such items and may be a request to create a wishlist without having the wishlist identify any specific items.

Next, process 300 proceeds to act 304, where a wishlist may be created in response to the request received in act 302. In some embodiments, the wishlist may be created only if information associated with the recipient is verified. For example, the wishlist may be created only if the address associated with the recipient is verified. As another example, the wishlist may be created only if organization information associated with the recipient is verified. As a specific example, if the recipient claims to be a non-profit organization, the wishlist may be created only if the non-profit status of the recipient is verified. Information associated with the recipient may be verified in any suitable way and may be verified automatically and/or manually. In some instances, the wishlist created in act 304 may be a wishlist not containing any items. Though, in other instances, a wishlist may be created and contain one or more items that the recipient may desire to receive.

Next, process 300 proceeds to at 306 where the recipient and any information associated with the recipient (e.g., information about the recipient, any wishlists associated with the recipient) may be assigned to one or more categories of recipients. This may be done in any suitable way. For example, the recipient may be assigned to a category indicative of a characteristic of the work done by the recipient. In this case, if the recipient is a nonprofit organization doing work in the area of homelessness, the recipient may be assigned to the homelessness, human services, and/or the poverty categories. Though, it should be recognized that the recipient and any information associated with the recipient may be organized in accordance with any suitable organization scheme, which is not limited to being based solely on categories and, for example, may be a hierarchical organization scheme any other suitable organization scheme. In some instances, the recipient may suggest/request to be assigned to a particular category. However, in other instances the recipient may be assigned to a particular category that may not correspond to a category that the recipient may have suggested/requested.

Next, process 300 proceeds to decision block 308, where it is determined whether the wishlist created in act 304 is to be edited. This determination may be made in any suitable way, as aspects of the invention are not limited in this respect. If it is determined, in decision block 308, that the wishlist is not to be edited, process 300 completes. On the other hand, if it is determined that the wishlist is to be edited, process 300 proceeds, via the “YES” branch, to act 310, where the wishlist created in act 304 may be edited.

A wishlist may be edited in any of numerous ways. For example, one or more items may be added and/or removed from the wishlist. This may be done in any suitable way. For example, the recipient associated with the wishlist and/or entity acting on behalf of such a recipient may provide input indicating which item or items to add and remove from the wishlist. This may be done in any suitable way and, as one non-limiting example, may be done by having the recipient select one or more items to add to the wishlist by identifying items that the recipient desires among items sold by an online store.

A wishlist may be edited by changing the cost of an item, or the contribution price of an item. A wishlist may also be edited by revising the information provided in association with one or more items, or in any other way that modifies the wishlist or the presentation of the wishlist. As another example, information associated with the recipient (e.g., address, mission statement, etc.) may be edited. As yet another example, information about one or more items (e.g., information providing the reasons for why the recipient desires to receive the item(s)) may be edited.

After the wishlist is edited, process 300 loops back to act 308 and acts 308-310 are repeated until it is determined that the wish list is not to be edited at which point process 300 may complete.

It should be recognized that process 300 is illustrative and that many variations of process 300 are possible. For example, in some embodiments, wishlists created for one or more recipients may not be categorized after they are created. As such, the wishlists may be categorized at a later time or not categorized.

The above-described embodiments of the present invention can be implemented in any of numerous ways. For example, the embodiments may be implemented using hardware, software or a combination thereof. When implemented in software, the software code may be executed on any suitable processor or collection of processors, whether provided in a single computer or distributed among multiple computers.

Components of data-entry systems described herein may be implemented using a single computer or its functionality may be distributed across multiple computers or servers. In such a setting, communication among system components/modules/interfaces may be realized in any suitable manner (e.g., wired, wireless, network-based connections) as the present invention is not limited in this respect.

It should be appreciated that a computer may be embodied in any of numerous forms, such as a rack-mounted computer, a desktop computer, a laptop computer, or a tablet computer. Additionally, a computer may be embodied in any device with suitable processing capabilities, including a Personal Digital Assistant (PDA), a smart phone or any other suitable portable or fixed electronic device.

Also, a computer may have one or more input and output devices. These devices may be used, among other things, to present a user interface. Examples of output devices that may be used to provide a user interface include printers or display screens for visual presentation of output, and speakers or other sound generating devices for audible presentation of output. Examples of input devices that may be used for a user interface include keyboards, microphones, and pointing devices, such as mice, touch pads, and digitizing tablets.

Such computers may be interconnected by one or more networks in any suitable form, including a local area network (LAN) or a wide area network (WAN), such as an enterprise network, an intelligent network (IN) or the Internet. Such networks may be based on any suitable technology and may operate according to any suitable protocol and may include wireless networks, wired networks, and/or fiber optic networks.

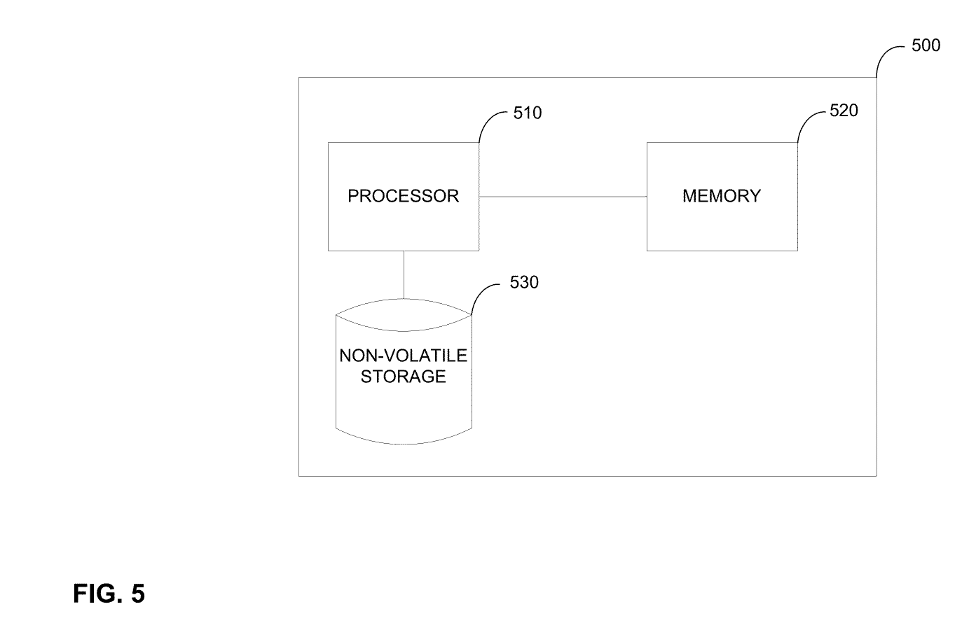

An illustrative implementation of a computer system 500 that may be used in connection with any of the embodiments of the invention described herein is shown in FIG. 5. The computer system 500 may include one or more processors 510 and one or more non-transitory computer-readable storage media (e.g., memory 520 and one or more non-volatile storage media 530). The processor 510 may control writing data to and reading data from the memory 520 and the non-volatile storage device 530 in any suitable manner, as the aspects of the invention described herein are not limited in this respect. To perform any of the functionality described herein, the processor 510 may execute one or more instructions stored in one or more computer-readable storage media (e.g., the memory 520), which may serve as non-transitory computer-readable storage media storing instructions for execution by the processor 510.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A computer system configured to assist in donating one or more items to at least one recipient selected from a plurality of potential recipients, the computer system comprising:
at least one computer readable medium for storing information regarding the plurality of potential recipients and, for each of the plurality of potential recipients, storing information regarding a plurality of items the respective potential recipient would like to receive as a donation; and
at least one processor capable of receiving information stored on the at least one computer readable medium, the at least one processor configured to perform:
presenting the donor with a plurality of items that a selected recipient desires to receive as a donation;
receiving first input indicating the donor's selection of at least one item from the plurality of items; and
interacting with the donor to allow the donor to donate at least a portion of the at least one selected item to the selected recipient.

2. The computer system of claim 1, wherein the at least one processor is configured to perform presenting the plurality of potential recipients to the donor.

3. The computer system of claim 1, wherein the at least one processor is configured to perform receiving input indicating a donor's selection of a recipient from the plurality of potential recipients.

4. The computer system of claim 1, wherein each of the plurality of potential recipients is a non-profit organization.

5. The computer system of claim 1, wherein at least one of the plurality of items is a good.

6. The computer system of claim 1, wherein at least one of the plurality of items is a service.

7. The computer system of claim 1, wherein interacting with the donor comprises allowing the donor to electronically purchase the at least one item.

8. The computer system of claim 1, wherein interacting with the donor comprises providing access to a website configured to allow the donor to electronically purchase the at least one item via the website.

9. A computer-implemented method for donating one or more items to at least one recipient selected from a plurality of potential recipients, the method comprising:
using at least one processor to perform:
presenting the donor with a plurality of items that a selected recipient desires to receive as a donation;
receiving first input indicating the donor's selection of at least one item from the plurality of items; and
interacting with the donor to allow the donor to donate at least a portion of the at least one selected item to the selected recipient.

10. The method of claim 9, further comprising using the at least one processor to present the plurality of potential recipients to the donor, wherein each of the plurality of potential recipients has an associated plurality of items that the respective recipient desires to receive as a donation.

11. The method of claim 9, further comprising using the at least one processor to receive input indicating a donor's selection of a recipient from the plurality of potential recipients.

12. The method of claim 9, wherein each of the plurality of potential recipients is a non-profit organization.

13. The method of claim 9, wherein at least one of the plurality of items is a good.

14. The method of claim 9, wherein at least one of the plurality of items is a service.

15. The method of claim 9, wherein interacting with the donor comprises allowing the donor to electronically purchase the at least one item.

16. The method of claim 9, wherein interacting with the donor comprises providing access to a website configured to allow the donor to electronically purchase the at least one item via the website.

17. At least one computer-readable medium encoded with instructions that, when executed on at least one computer, perform a method of donating one or more items to at least one recipient selected from a plurality of potential recipients, the method comprising:
presenting the donor with a plurality of items that a selected recipient desires to receive as a donation;
receiving first input indicating the donor's selection of at least one item from the plurality of items; and
interacting with the donor to allow the donor to donate at least a portion of the at least one selected item to the selected recipient.

18. The at least one computer readable medium of claim 17, further comprising presenting the plurality of potential recipients to the donor, wherein each of the plurality of potential recipients has an associated plurality of items that the respective recipient desires to receive as a donation.

19. The at least one computer readable medium of claim 17, further comprising receiving input indicating a donor's selection of a recipient from the plurality of potential recipients.

20. The at least one computer readable medium of claim 17, wherein each of the plurality of potential recipients is a non-profit organization.

21. The at least one computer readable medium of claim 17, wherein at least one of the plurality of items is a good.

22. The at least one computer readable medium of claim 17, wherein at least one of the plurality of items is a service.

23. The at least one computer readable medium of claim 17, wherein interacting with the donor comprises allowing the donor to electronically purchase the at least one item.

24. The at least one computer readable medium of claim 17, wherein interacting with the donor comprises providing access to a website configured to allow the donor to electronically purchase the at least one item via the website.
